(19) United States
(12) Patent Application Publication
(10) Pub. No.: US 2015/0158714 A1
(43) Pub. Date: Jun. 11, 2015

(54) SYSTEM AND METHOD OF DISPENSING FOOD PRODUCT FROM A PUMP-LESS, REFRIGERATED FOOD DISPENSING SYSTEM

(71) Applicant: Carrier Commercial Refrigeration, Inc., Farmington, CT (US)

(72) Inventors: George C. Boyer, Rockton, IL (US); Curtis J. Scadden, Waunakee, WI (US); Scott A. Glawe, Roscoe, IL (US)

(73) Assignee: Carrier Commercial Refrigeration, Inc.

(21) Appl. No.: 14/505,899

(22) Filed: Oct. 3, 2014

Related U.S. Application Data
(60) Provisional application No. 61/912,584, filed on Dec. 6, 2013.

(51) Int. Cl. B67D 7/02; B67D 7/84; B67D 7/80

(52) U.S. Cl. CPC B67D 7/0216; B67D 7/80; B67D 7/84

(57) ABSTRACT

A pump-less, refrigerated food dispensing system including a refrigerated cabinet and a cassette drive system disposed within the refrigerated cabinet. The cassette drive system including at least one cartridge holder, at least one compression assembly operably coupled to the at least one cartridge holder, at least one motor operably coupled to the at least one compression assembly, and at least one switching mechanism operably coupled to the at least one motor. A method for dispensing food from a pump-less refrigerated food dispensing system wherein at least one step includes transferring power from one of the at least two motors to another of the at least two motors when the compression device is at a final predetermined position.

### CROSS REFERENCE TO RELATED APPLICATIONS

The present application is related to, and claims the priority benefit of, U.S. Provisional Patent Application Ser. No. 61/912,584 filed Dec. 6, 2013, the contents of which are hereby incorporated in their entirety into the present disclosure.

### TECHNICAL FIELD OF THE DISCLOSED EMBODIMENTS

The presently disclosed embodiments generally relate to appliances for on-demand dispensing of food product, and more particularly, to a system and method for dispensing food product from a pump-less, refrigerated food dispensing system.

### BACKGROUND OF THE DISCLOSED EMBODIMENTS

In a conventional refrigerated food dispensing system, peristaltic pumping technology is used to expel food product from within. A peristaltic pump is a type of positive displacement pump used for pumping a variety of food products, for example yogurt. The food product is contained within a flexible tube fitted inside a circular pump casing (although linear peristaltic pumps have been made). A rotor with a number of “rollers”, “shoes”, “wipers”, or “lobes” attached to the external circumference of the rotor compresses the flexible tube. As the rotor turns, the part of the tube under compression is pinched closed (or “occludes”) thus forcing the food product to be pumped to move through the tube. Additionally, as the tube opens to its natural state after the passing of the roller (“restitution” or “resilience”), food product flow is induced to the pump cycle.

In certain applications, for instance the dispensing of Greek yogurt product, a peristaltic pump may compromise the quality of the product. Additionally, a peristaltic pump may produce food product waste. As the food product container becomes empty, the dispensing of product may cease. This may require the food product container to be removed and shaken to move food product towards the outlet to allow the pump to expel the remaining product. There is, therefore, a need for a food dispensing system that does not compromise the quality of the product and reduces food product waste.

### SUMMARY OF THE DISCLOSED EMBODIMENTS

In one aspect, a pump-less, refrigerated food dispensing system is provided. The system includes a refrigerated cabinet and a cassette drive system disposed within the refrigerated cabinet. The system further includes a dispensing mechanism operably coupled to the refrigerated cabinet. In one embodiment, the dispensing mechanism may be operably coupled to a food product container via a conduit.

In at least one embodiment, the cassette drive system includes at least one cartridge holder. In at least one embodiment, the at least one cartridge holder includes a cartridge holder bottom wall, and cartridge holder opposing side walls extending substantially perpendicular from the cartridge holder bottom wall to form a cartridge holder cavity therein.

In at least one embodiment, the cassette drive system further includes at least one compression assembly operably coupled to the at least one cartridge holder. In one embodiment, the at least one compression assembly includes a compression device operably coupled to at least one gear mechanism. In one embodiment, the compression device may be a roller. In at least one embodiment, the compression device may be disposed within the cartridge holder cavity. In at least one embodiment, the at least one compression assembly includes at least one sensor disposed thereon.

In at least one embodiment, the cassette drive system further includes at least one motor operably coupled to the at least compression assembly. In at least one embodiment, the cassette drive system further includes at least one switching device operably coupled to each of the at least one motors.

In at least one embodiment, the cassette drive system further includes a removable cartridge disposed within each of the at least one cartridge holders. In one embodiment, the removable cartridge includes a removable cartridge bottom wall and removable cartridge opposing side walls extending substantially perpendicular from the removable cartridge bottom wall to form a removable cartridge cavity therein. In one embodiment, the removable cartridge bottom wall includes a hinge portion. In one embodiment, one of the removable cartridge opposing side walls includes at least one attachment means

In one aspect a method of dispensing food from a pump-less, refrigerated food dispensing system is provided. The method includes step of operating the at least one compression assembly to place the compression device in a first predetermined position. In one embodiment, the first predetermined position may include the compression device positioned above a food product container

In at least one embodiment, the method includes the step of operating the at least one compression assembly to place the compression device in contact with the food product container. In at least one embodiment, the method includes the step of operating the dispensing mechanism to extract food product.

In at least one embodiment, the method includes the step of commanding food product to be extracted from the system. In one embodiment, commanding food product to be extracted from the system includes operating the dispensing mechanism.

In at least one embodiment, the method includes the step of applying pressure to the food product container. In one embodiment, applying pressure to the food product container includes operating the at least one compression assembly. In one embodiment, operating the at least one compression assembly includes moving the compression device in a downward vertical direction.

In at least one embodiment, the method includes the step of determining whether the compression device is at a predetermined intermediate position. In one embodiment, determining the predetermined intermediate position includes operating at least one sensor operably coupled to the at least one compression assembly. In another embodiment, determining the predetermined intermediate position includes counting steps of the at least one motor. In at least one embodiment, the method includes the step of indicating the food product container may be in a first condition, if it is determined that the compression device is at the predetermined intermediate position.

In at least one embodiment, the method includes the step of determining whether the compression device is at a final predetermined position, if it is not determined that the compression device is at the predetermined intermediate position. In one embodiment, determining the final predetermined position includes operating the at least one sensor operably coupled to the at least one compression assembly. In another embodiment, determining the final predetermined position includes counting steps of the at least one motor. In at least one embodiment, the method includes the step of indicating the food product container may be in a second condition, if it is determined that the compression device is at the final predetermined position.

In at least one embodiment, transferring operational power from one of the at least two motors to another of the at least two motors, if it is determined the compression device is at the second predetermined position. In one embodiment, transferring power from one of the at least two motors to another of the at least two motors includes operating the at least one switching device.

In at least one embodiment, the method returns to step of operating the at least one compression assembly to place the compression device in the first predetermined location, after operational power has been transferred from one of the at least one motors to another of the at least one motors.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a cross-sectional perspective view of a food dispensing system according to at least one embodiment of the present disclosure;

FIG. 2A is a side view of a removable cartridge according to at least one embodiment of the present disclosure;

FIG. 2B is perspective view of a removable cartridge according to at least one embodiment of the present disclosure; and

FIG. 3 is a method of dispensing food product from a pump-less refrigerated food dispensing system according to at least one embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

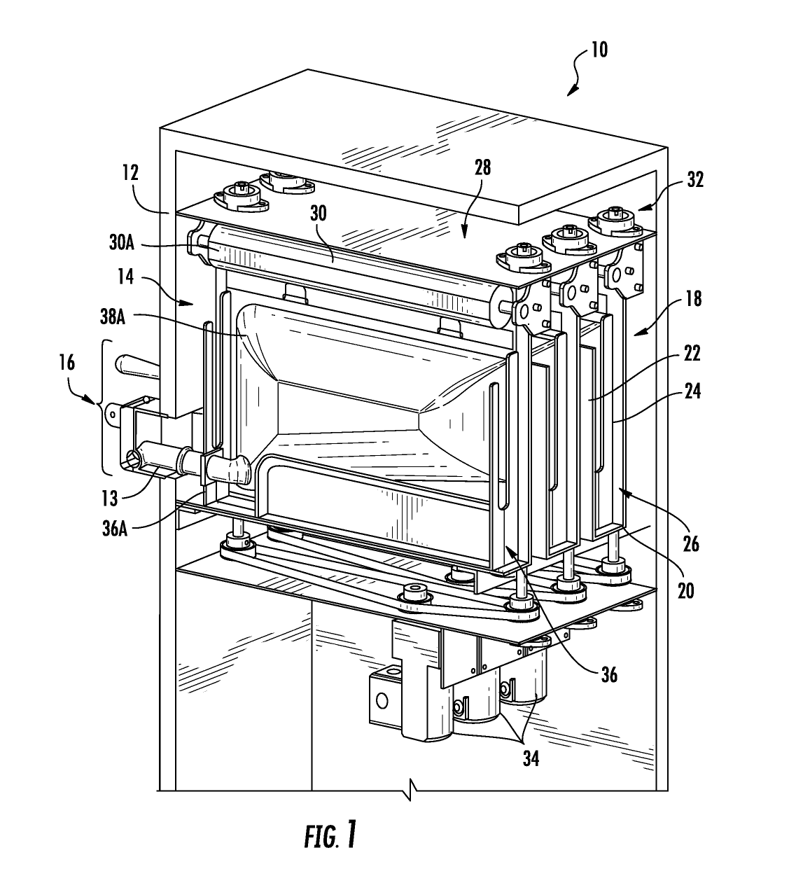

FIG. 1 illustrates a pump-less, refrigerated food dispensing system, generally referenced at 10. The system 10 includes a refrigerated cabinet 12 and a cassette drive system 14 disposed within the refrigerated cabinet 12. The system 10 further includes a dispensing mechanism 16 operably coupled to the refrigerated cabinet 12. In one embodiment, the dispensing mechanism 16 may be operably coupled to a food product container, later described herein, via a conduit 13. The conduit 13 may include a coupling (not shown) to allow for the connection and disconnection of the conduit 13 to the food product container.

In at least one embodiment, the cassette drive system 14 includes at least one cartridge holder 18. In at least one embodiment, the at least one cartridge holder 18 includes a cartridge holder bottom wall 20, and cartridge holder opposing side walls 22 and 24 extending substantially perpendicular from the cartridge holder bottom wall 20 to form a cartridge holder cavity 26 therein.

In at least one embodiment, the cassette drive system 14 further includes at least one compression assembly 28 operably coupled to the at least one cartridge holder 18. In one embodiment, the at least one compression assembly 28 includes a compression device 30 operably coupled to at least one gear mechanism 32. In one embodiment, the compression device 30 may be a roller. It will be appreciated that the compression device 30 may be any suitable object, for example a blade to name a non-limiting example, configured to apply pressure onto a surface. The at least one gear mechanism 32 is configured to rotate; thereby, moving the compression device 30 in a downward vertical direction. It will be appreciated that in other embodiments the compression device 30 may move in an upward vertical direction or in a lateral direction. In at least one embodiment, the compression device 30 may be disposed within the cartridge holder cavity 26. In at least one embodiment, the at least one compression assembly 28 includes at least one sensor (not shown) disposed thereon to determine the position of the compression device 30. For example, the at least one sensor may be disposed on the compression device 30. It will be appreciated that the at least one sensor may be placed in any suitable location to determine the position of the compression device 30.

In at least one embodiment, the cassette drive system 14 further includes at least one motor 34 operably coupled to the at least one compression assembly 28. It will be appreciated that the at least one motor 34 may be internal or external to the at least one compression assembly 28. For example, the at least one motor 34 may be operably coupled to the at least one gear mechanism 32. The at least one motor 34 is configured to rotate the at least one gear mechanism 32 to move the compression device 30 in a vertical or lateral direction. It will be appreciated that the at least one motor 34 may be any suitable motor, for example, a stepper motor to name one non-limiting example, configured to rotate the at least one gear mechanism 32

In at least one embodiment, the cassette drive system 14 further includes at least one switching device (not shown) operably coupled to each of the at least one motors 36. The at least one switching device is operable to switch operational power between each of the at least one motors 34.

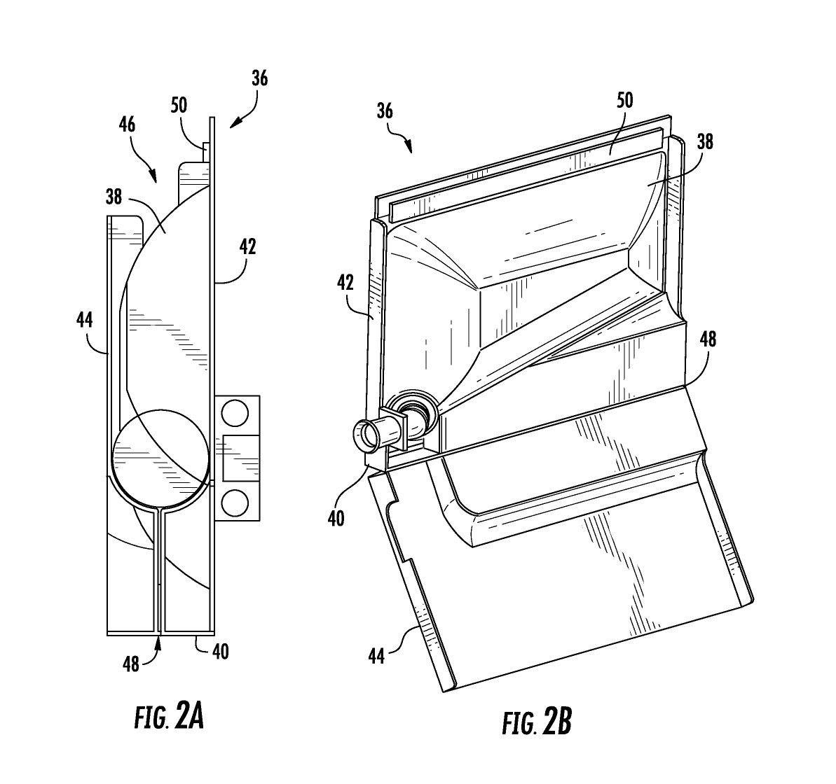

In at least one embodiment, the cassette drive system 14 further includes a removable cartridge 36 disposed within each of the at least one cartridge holders 18. As shown in FIGS. 2A and 2B, the removable cartridge 36 may be configured to hold a food product container 38, for example Greek yogurt container to name one non-limiting example, therein. The food product container 38 may be configured to be biased towards an outlet port thereon to promote the expulsion of substantially all of the food product stored therein. In one embodiment, the removable cartridge 36 includes a removable cartridge bottom wall 40 and removable cartridge opposing side walls 42 and 44 extending substantially perpendicular from the removable cartridge bottom wall 40 to form a removable cartridge cavity 46 therein. In one embodiment, the removable cartridge bottom wall 40 includes a hinge portion 48. The hinge portion 48 is operable to open and close the removable cartridge 36 for the removal and insertion of the food product container 38. In one embodiment, one of the removable cartridge opposing side walls 42 and 44 includes an attachment means 50, such as a flexible compression bar to name one non-limiting example, operable to hold the food product container 38 within the removable cartridge cavity 46 in a desired location and configuration. For example, the removable cartridge opposing side wall 42 may include a flexible compression bar 50 operable to hold a food product container 38 by engaging a portion of the food product container 38 between the flexible compression bar 50 and the removable cartridge opposing side wall 42 to hold the food product container 38 in a desired location and orientation for dispensing.

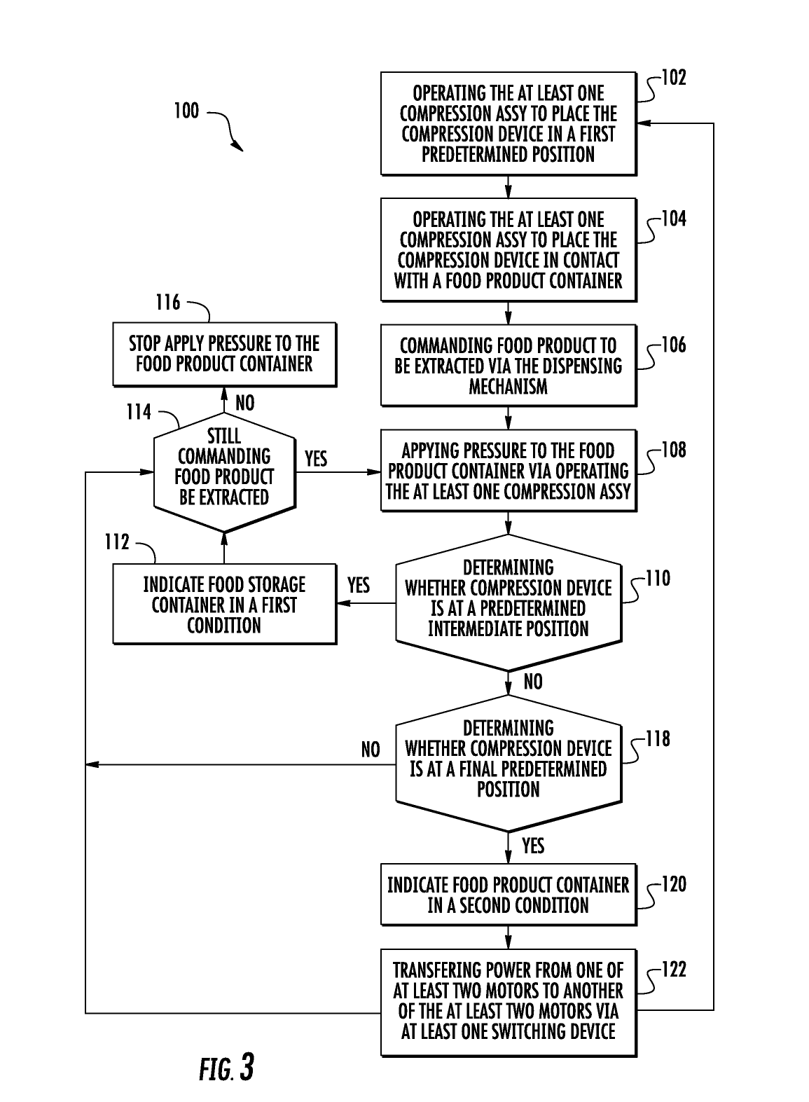

FIG. 3 illustrates a method 100 of dispensing food from a pump-less, refrigerated food dispensing system 10. The method 100 includes step 102 of operating the at least one compression assembly 28 to place the compression device 30 in a first predetermined position. In one embodiment, the first predetermined position may include the compression device 30 positioned above the food product container 38. For example, the initial position of compression device 30A may be above the food product container 38A to allow for removal of the removable cartridge 36A to install the food product container 38A inside the removable cartridge 36A. It will be appreciated that the first predetermined position may be in any suitable location to allow the removal of the removable cartridge 36.

In at least one embodiment, after the insertion of the removable cartridge 36, the method proceeds to step 104 of operating the at least one compression assembly 28 to place the compression device 30 in contact with the food product container 38. For example, after the installation of the removable cartridge 36A, the compression device 30A may be placed in contact with food product container 38A in close proximity to the food product stored therein to allow the system 10 to be primed for immediate use.

In at least one embodiment, step 106 includes commanding food product to be extracted from the system 10. In one embodiment, commanding food product be extracted from the system includes operating the dispensing mechanism 16. For example, food product may be extracted by opening a valve to allow the flow of food product through the dispensing mechanism 16.

In at least one embodiment, step 108 includes applying pressure to the food product container 38. In one embodiment, applying pressure to the food product container 38 includes operating the at least one compression assembly 28. In one embodiment, operating the at least one compression assembly 28 includes moving the compression device 30 in a downward vertical direction. It will be appreciated that the compression device 30 may move in an upward vertical direction or in a lateral direction in other embodiments. For example, after the user operates the dispensing mechanism 16, motor 34A rotates the at least one gear mechanism 32A, causing the compression device 30A to continuously move in a downward vertical direction placing pressure on the food product container 38A until the user stops operating the dispensing mechanism 16. As pressure is applied to the food product container 38A, food product is forced out of the dispensing mechanism 16. It will be appreciated that the speed of the at least one motor 34 may be adjusted based on the food product being dispensed. In embodiments where the at least one motor 34 includes a stepper motor, it will be appreciated that the compression device 30A may move in a downward vertical direction for a predetermined distance to provide portion control. For example, if a user desires a small portion of food product, the compression device 30A moves a predetermined distance (e.g. 10 steps to name one non-limiting example) in a downward vertical direction that designates a small portion of food product. If a user desires a large portion of food product, the compression device 30A moves a predetermined distance (e.g. 40 steps to name one non-limiting example) in a downward vertical direction that designates a large portion of food product

In at least one embodiment, step 110 includes determining whether the compression device 30 is at a predetermined intermediate position. In one embodiment, determining the predetermined intermediate position includes operating at least one sensor operably coupled to the at least one compression assembly 28. In another embodiment where a stepper motor is used for the motor 34, determining the predetermined intermediate position includes counting steps of the at least one motor 34. If it is determined that the compression device 30 is at the predetermined intermediate position, the method proceeds to step 112 of indicating the food product container 38 may be in a first condition. For example, a sensor may be placed in a location designating the food product container 38A may be in a half empty condition. When the at least one compression assembly 28A triggers the sensor, an indicator, for example illuminating a light emitting diode to name one non-limiting example, may alert the half empty condition of the food product container 38A. Alternatively, the at least one motor 34A may count the number of steps required to reach the predetermined intermediate position. Once the number of steps have been completed, an indicator, for example illuminating a light emitting diode to name one non-limiting example, may alert the half empty condition of the food product container 38A.

After it is indicated that the food product container 38 is in the first condition, the method proceeds to step 114 of determining whether the command to extract food product is still present. If the command to extract food product is present, the method returns to step 108 of applying pressure to the food product container 38. If the command to extract food product is not present, the method proceeds to step 116 to stop applying pressure to the food product container 38.

In at least one embodiment, if it is determined that the compression device 30 is not at the predetermined intermediate position, the method proceeds to step 118 of determining whether the compression device 30 is at a final predetermined position. In one embodiment, determining the final predetermined position includes operating the at least one sensor operably coupled to the at least one compression assembly 28. In another embodiment, where a stepper motor for the motor 34, determining the final predetermined position includes counting steps of the at least one motor 34. In at least one embodiment, if it is not determined that the compression device 30 is at the final predetermined position, the method proceeds to step 114 to determine whether the command to extract food product is still present. If the command to extract food product is present, the method returns to step 108 of applying pressure to the food product container 38. If the command to extract food product is not present, the method proceeds to step 116 to stop applying pressure to the food product container 38. For example, a sensor may be placed in a location designating the food product container 38A may be in an empty condition. Alternatively, when a stepper motor is used for motor 34, the stepper motor may count the number of steps required to reach the final predetermined position.

In at least one embodiment, if it is determined that the compression device 30 is at the final predetermined location, the method proceeds to step 120 of indicating the food product container 38 may be in a second condition. For example, when the at least one compression assembly 28A triggers the sensor, or the at least one motor 34A counts the number of steps required to reach the final predetermined condition, an indicator, for example illuminating a light emitting diode to name one non-limiting example, may alert the empty condition of the food product container 38A.

In at least one embodiment, if it is determined the compression device 30 is at the final predetermined position, the method proceeds to step 122 transferring operational power from one of the at least two motors 34 to another of the at least two motors 34. In one embodiment, transferring power from one of the at least two motors 34 to another of the at least two motors includes operating the at least one switching device (not shown). For example, after the food product has been expelled from the food product container 38A, the switching mechanism transfers operational power from motor 34A to motor 34B. After operational power has been transferred, motor 34B may drive the at least one gear mechanism 32B causing compression device 30B to apply pressure to food product container 38B; thus, expelling food product through the dispensing mechanism 16 without interruption.

In at least one embodiment, after operational power has been transferred from one of the at least two motors 34 to another of the at least two motors 34, the method proceeds to step 114 to determine whether the command to extract food product is still present. If the command to extract food product is present, the method returns to step 108 of applying pressure to the food product container 38. If the command to extract food product is not present, the method proceeds to step 116 to stop applying pressure to the food product container 38. Concurrently, the method returns to step 102 of operating the at least one compression assembly 28 to place the compression device 30 in the first predetermined location. For example, once operational power is transferred from motor 34A to another of the at least two motors 34, pressure may be applied to another food product container 38, via another of the at least one compression assemblies 28, to continue dispensing food product with minimal interruption. In addition, once operational power is transferred from motor 34A, reverse power is provided to motor 34A to reverse the rotation thereof. As the motor 34A reverses rotation, the compression assembly 28A moves in a upward vertical direction until the compression device 30A is returned to the first predetermined position. One the compression device 30A is returned to the first predetermined position, the removable cartridge 36A may be removed from the cartridge holder 18, and the food product container 38A may be replaced.

It will be appreciated that the system 10 includes a cassette drive system 14 that may transfer power from one of the at least one motors 34 to another of the at least one motors 34 when the compression device 30 is located at a second predetermined position.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A pump-less, refrigerated food dispensing system comprising:
a refrigerated cabinet; and
a cassette drive system disposed within the refrigerated cabinet;
wherein the cassette drive system comprises:
at least one cartridge holder;
at least one compression assembly operably coupled to the at least one cartridge holder;
at least one motor operably coupled to the at least one compression assembly; and
at least one switching mechanism operably coupled to the at least one motor.

2. The system of claim 1 further comprising a dispensing mechanism operably coupled to the refrigerated cabinet.

3. The system of claim 2, wherein the at least one cartridge holder comprises a cartridge holder bottom wall and opposing cartridge holder side walls extending substantially perpendicular from the cartridge holder bottom wall to form a cartridge holder cavity therein.

4. The system of claim 3, wherein the at least one compression assembly comprises at least one gear mechanism and a compression device operably coupled to the at least one gear mechanism.

5. The system of claim 4, wherein the compression device comprises a roller.

6. The system of claim 4, wherein the compression device is disposed within the cartridge holder cavity.

7. The system of claim 6, wherein the at least one compression assembly further comprises at least one sensor disposed thereon.

8. The system of claim 3, further comprising a removable cartridge disposed within each of the at least one cartridge holders.

9. The system of claim 8, wherein the removable cartridge comprises a removable cartridge bottom wall and removable cartridge opposing side walls extending substantially perpendicular from the removable cartridge bottom wall to form a removable cartridge cavity therein.

10. The system of claim 9, wherein the removable cartridge bottom wall includes a hinge portion.

11. The system of claim 9, further comprising an attachment means operably coupled to one of the removable cartridge opposing side walls.

12. The system of claim 11, further comprising a food product container disposed within the removable cartridge cavity and engaged with the attachment means.

13. A method for dispensing food from a pump-less refrigerated food dispensing system including a refrigerated cabinet, a cassette drive system disposed within the refrigerated cabinet, wherein the cassette drive system includes at least one cartridge holder, at least one compression assembly, including a compression device, operably coupled to the at least one cartridge holder, at least two motors, each operably coupled to the at least one compression assembly, at least one switching mechanism operably coupled to the at least two motors, and a dispensing mechanism operably coupled to the refrigerated cabinet, the method comprising the steps of:
(a) commanding a food product to be dispensed;
(b) applying pressure to a food product container, thereby causing food product to flow from the food product container to the dispensing mechanism;
(c) transferring power from one of the at least two motors to another of the at least two motors when the compression device is at a final predetermined position.

14. The method of claim 13, wherein a food product container is disposed within a removable cartridge.

15. The method of claim 14, wherein a removable cartridge is disposed within each of the at least one cartridge holders.

16. The method of claim 15, wherein commanding the food product to be dispensed comprises operating the dispensing mechanism to allow the food product to be extracted from a food product container

17. The method of claim 18, wherein step (a) further comprises operating the at least one compression assembly to place the compression device in a first predetermined position.

18. The method of claim 17, wherein the first predetermined position comprises the compression device positioned above the food product container.

19. The method of claim 18, further comprises operating the at least one compression assembly to place the compression device in contact with the food product container.

20. The method of claim 15, wherein applying pressure to the food product container comprises operating the at least one compression assembly.

21. The method of claim 20, wherein operating the at least one compression assembly comprises moving the compression device in vertical direction.

22. The method of claim 20, wherein step (b) further comprises determining whether the compression device is at a predetermined intermediate position.

23. The method of claim 22, wherein determining whether the compression device is at a predetermined intermediate position comprises operating at least one sensor operably coupled to the compression assembly.

24. The method of claim 22, wherein determining whether the compression device is at a predetermined intermediate position comprises counting steps of the at least one motor.

25. The method of claim 22, further comprising indicating the food product container is in a first condition when it is determined the compression device is at the predetermined intermediate position.

26. The method of claim 13, wherein transferring power from one of the at least two motors to another of the at least two motors comprises operating the at least one switching device.

27. The method of claim 13, wherein step (c) further comprises determining whether the compression device is at the final predetermined position.

28. The method of claim 27, wherein determining whether the compression device is at the final predetermined position comprises operating at least one sensor operably coupled to the compression assembly.

29. The method of claim 27, wherein determining whether the compression device is at the final predetermined position comprises counting steps of the at least one motor.

30. The method of claim 27, further comprising indicating the food product container is in a second condition when it is determined the compression device is at the final predetermined position.
